(19) United States
(12) Patent Application Publication
(10) Pub. No.: US 2009/0071598 A1
(43) Pub. Date: Mar. 19, 2009

(54) Method of producing resin sheet

(75) Inventors: Katsuhiko Takada, Shizuoka (JP); Takahiro Hayashi, Shizuoka (JP); Takekazu Yamamoto, Shizuoka (JP); Yasuyuki Hara, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 11/886,898

(22) PCT Filed: Mar. 15, 2006
(86) PCT No.: PCT/JP2006/305623

§ 371 Date: Sep. 21, 2007

(30) Foreign Application Priority Data
Mar. 23, 2005 (JP) 2005-084559

(51) Int. Cl. B32B 37/10

(52) U.S. Cl. 156/209

(57) ABSTRACT

In the method of producing a resin sheet of the present invention, a first resin material and a second resin material are stacked and pressed by an emboss roller and a nip roller, thereby transferring irregularities on the surface of the emboss roller to the first resin material and closely contacting the first resin material to the second resin material, and the resulting laminate is wound onto a releasing roller to be released from the emboss roller. As the two resin materials are stacked in this way, unevenness on the backside produced immediately after molding is hardly generated and the desired cross-sectional shape can be obtained even in the case of a resin sheet with a wide thickness distribution in the width direction upon molding.

### TECHNICAL FIELD

The present invention relates to a method of producing a resin sheet, more specifically to a method of producing a resin sheet suitably used for a light guide plate positioned on the backside of various display devices or various optical devices.

### BACKGROUND ART

Referring to resin sheets used in various optical devices, Fresnel lenses and lenticular lenses are used in a wide variety of fields. These resin sheets have patterned irregularities on the surface, and due to such irregularities, Fresnel lenses and lenticular lenses exhibit their optical properties.

Regarding the method of producing such resin sheets, various proposals have been made so far (see Patent Documents 1 to 4). In all of these techniques, roll forming is employed in order to improve productivity.

For example, in Patent Document 1, transferability has been improved by making special arrangement for cooling means before releasing a resin sheet from a roller. Patent Document 2 discloses a method of producing a Fresnel lens using a roller onto which a die is wound.

In Patent Document 3, a heat buffer is put inside a forming roll to improve productivity and transferability. In Patent Document 4, corona discharge is employed so as to improve transferability and reduce defects.

In these conventional arts, a typical roll forming technique employs a configuration illustrated in FIG. 4. The apparatus comprises a die 2 for sheet which forms a resin material 1 melted in an extruder (representation abbreviated) into a sheet, a stamper roller 3 having irregularities on the surface, a mirror finished roller 4 positioned against the stamper roller 3, and a mirror finished roller for releasing 5 faced with the stamper roller 3 and positioned on the opposite side of the mirror finished roller 4.

The sheet-shaped resin material 1 extruded from the die 2 is pressed by the stamper roller 3 and the mirror finished roller 4 to transfer the irregularities on the surface of the stamper roller 3 to the resin material 1, and the resin material 1 is then wound onto the mirror finished roller for releasing 5 to be released from the stamper roller 3.

[Patent Document 1] Japanese Patent Application Laid-Open No. 8-31025

[Patent Document 2] Japanese Patent Application Laid-Open No. 7-314567

[Patent Document 3] Japanese Patent Application Laid-Open No. 2003-53834

[Patent Document 4] Japanese Patent Application Laid-Open No. 8-287530

### DISCLOSURE OF THE INVENTION

The above-described techniques, however, all relate to a method of producing a relatively thin resin sheet, and thus are not suitable for producing a relatively thick resin sheet. In particular, when a resin sheet with a wide thickness distribution in the width direction upon molding is produced, the desired cross-sectional shape is difficult to obtain.

For instance, when PMMA (polymethyl methacrylate resin) is subjected to roll forming after extrusion and thickness distribution is given in the width direction to create a difference in thickness between the thickest part and the thinnest part of 1 mm or more, the resulting sheet has problems that the surface or the other surface of the sheet becomes uneven (shrinkage cavity generated by shrinkage of resin upon curing, elastic recovery distribution), the entire transfer rate of surface profile is decreased and that sharp edge forms cannot be transferred.

The present invention has been made in view of such circumstances and aims at providing a method of producing a resin sheet particularly suitably used for a light guide plate positioned on the backside of various display devices or various optical devices, which can give the desired cross-sectional shape when a resin sheet with a wide thickness distribution in the width direction upon molding is produced.

To accomplish the aforementioned object, the present invention provides a method of producing a resin sheet, comprising: stacking a sheet-shaped first resin material extruded from a first die and a sheet-shaped second resin material extruded from a second die, pressing the stacked resin materials by an emboss roller and a nip roller positioned against the emboss roller so that the first resin material comes into contact with the emboss roller and the second resin material comes into contact with the nip roller, transferring irregularities on the surface of the emboss roller to the first resin material and closely contacting the first resin material to the second resin material, and releasing the closely contacted first resin material and second resin material from the emboss roller by winding the closely contacted materials onto a releasing roller positioned against the emboss roller.

According to the present invention, the first resin material and the second resin material are stacked and pressed by an emboss roller and a nip roller, thereby transferring irregularities on the surface of the emboss roller to the first resin material and closely contacting the first resin material to the second resin material, and the resulting laminate is wound onto a releasing roller to be released from the emboss roller. By stacking the two resin materials as described above, unevenness on the backside produced immediately after molding is hardly generated and the desired cross-sectional shape can be obtained even in the case of a resin sheet with a wide thickness distribution in the width direction upon molding.

While the present invention employs a configuration in which the first resin material extruded from the first die and the second resin material extruded from the second die are stacked, configurations using a multi-manifold die or a feed block type die instead of the above two dies are equivalent to the configuration of the present invention. In other words, such configurations have equivalent function and provide an equivalent effect.

In the present invention, it is preferred that the aforementioned nip roller and/or the aforementioned releasing roller have/has irregularities on the surface. When the nip roller and/or the releasing roller have/has irregularities on the surface as described above, a resin sheet having irregularities on both sides can be obtained.

In that case, the desired cross-sectional shape can be formed on both sides, for example, by forming irregularities with a wide thickness distribution in the width direction on the first resin material by the emboss roller, forming irregularities with a distribution of thickness in the width direction narrower than that on the second resin material by the nip roller and/or the releasing roller, and stacking them. For example, a lenticular lens is formed on the surface and irregularities with pitches an order of magnitude narrower than those of the lens on the backside to form a scattering surface.

In the present invention, it is preferred that the first resin material has a glass transition temperature Tg1 lower than a glass transition temperature Tg2 of the second resin material. When the first resin material has a glass transition temperature Tg1 lower than the glass transition temperature Tg2 of the second resin material as described above, it is helpful for forming irregularities on the first resin material with a wide thickness distribution in the width direction and forming irregularity on the second resin material whose thickness distribution in the width direction is narrower than that of irregularities on the second resin material.

The “glass transition temperature Tg” refers to a temperature at which an organic high molecular weight material shifts to high temperature supercooled liquid or rubber-like substances from a low temperature glass state.

In the present invention, it is preferred that the irregularities transferred to the first resin material and/or the second resin material create a difference in thickness in the width direction between the thickest part and the thinnest part of a laminate of the first resin material and the second resin material of 1 mm or more. In the present invention, it is also preferred that a laminate of the first resin material and the second resin material has a thickness of 5 mm or less at the thinnest part. As described above, the present invention has an advantage in forming a cross-sectional shape of a resin material which has been difficult to mold.

### ADVANTAGES OF THE INVENTION

As described above, according to the present invention, the desired cross-sectional shape can be obtained even in the case of a resin sheet with a wide thickness distribution in the width direction upon molding.

### BRIEF DESCRIPTION OF THE DRAWINGS

FIG. 1 is a schematic view illustrating an example of production line for a resin sheet to which the present invention is applied;

FIG. 2 is a perspective view illustrating a linearly cut edge of a resin material after molding;

FIG. 3 is a perspective view illustrating a linearly cut edge of a resin material after molding; and

FIG. 4 is a schematic view illustrating an example of conventional production line for a resin sheet.

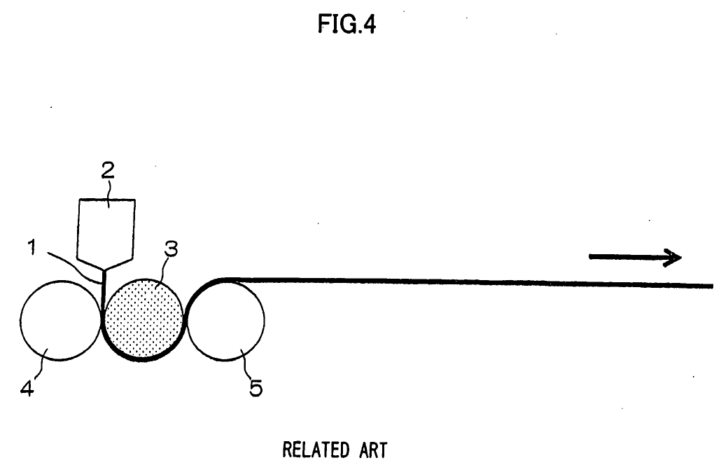

### DESCRIPTION OF SYMBOLS

10 . . . production line for resin sheet
12 . . . die (first die)
14 . . . first resin material
15 . . . die (second die)
16 . . . emboss roller
17 . . . second resin material
18 . . . nip roller
22 . . . guide roller
24 . . . releasing roller
30 . . . gradual cooling zone
32 . . . laminate

### BEST MODE FOR CARRYING OUT THE INVENTION

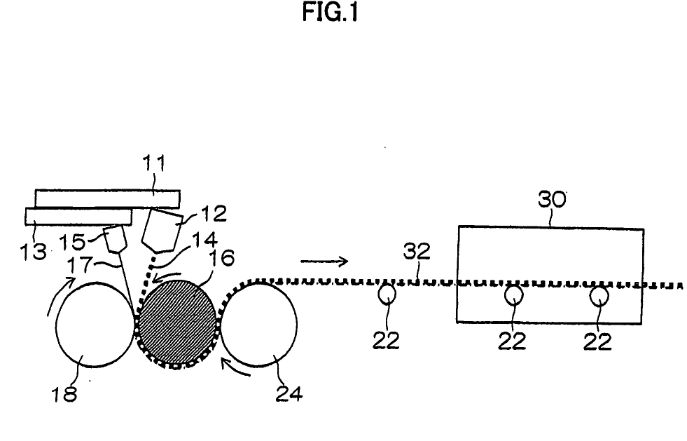

In the following, preferred embodiments of the method of producing a resin sheet of the present invention are described in detail with reference to the attached drawings. FIG. 1 is a schematic view illustrating an example of production line for a resin sheet to which the method of producing a resin sheet of the present invention is applied.

The production line 10 of a resin sheet is composed of a die 12 which is the first die for sheet for forming the first resin material 14 melted in an extruder 11 into a sheet, a die 15 which is the second die for sheet for forming the second resin material 17 melted in an extruder 13 into a sheet, an emboss roller 16 having irregularities on the surface, a nip roller 18 positioned against the emboss roller 16, a releasing roller 24 positioned against the emboss roller 16 and a plurality of guide rollers 22, 22 . . . which support transfer of a laminate 32 of the first resin material 14 and the second resin material 17.

The slit size of the die 12 is designed so that the extruded molten first resin material 14 is wider than the emboss of the emboss roller 16, and positioned so that the molten first resin material 14 from the die 12 is extruded into an area between the emboss roller 16 and the nip roller 18.

Likewise, the slit size of the die 15 is designed so that the extruded molten second resin material 17 is wider than the emboss of the emboss roller 16, and positioned so that the molten second resin material 17 from the die 15 is extruded into an area between the emboss roller 16 and the nip roller 18.

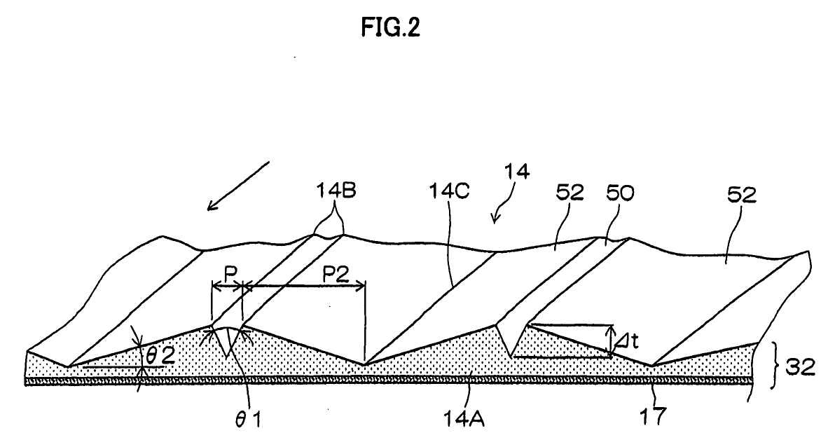

The emboss roller 16 has patterned irregularities on its surface. The patterned irregularities may have a shape opposite from the shape of, for example, the first resin material 14 after molding shown in FIG. 2. FIG. 2 is a perspective view illustrating a linearly cut edge 14A of the first resin material 14 (the laminate 32) after molding.

On the other hand, the surface of the nip roller 18 is flat and smooth. Although the nip roller 18 has a flat surface in this embodiment, it may have patterned irregularities as the emboss roller 16 does.

Specifically, the laminate 32 (the second resin material 17) has a flat backside, and a linear irregularity pattern parallel to the arrow is formed on the surface of the first resin material 14. The arrow indicates the traveling direction of the first resin material 14. Thus, an endless groove having a shape opposite from the shape of the edge 14A may be formed on the surface of the emboss roller 16. The irregularity pattern on the surface of the first resin material 14 will be described in detail later.

Referring to the material of the emboss roller 16, useful are various steel members, stainless steel, copper, zinc, brass, materials having a core made of such metal and rubber-lined on the surface, those metal materials plated with HCr, Cu or Ni, ceramics and various composite materials.

Regarding the method of forming irregularity patterns on the surface of the emboss roller 16, combination of cutting with an NC lathe and buffing finish is generally preferably adopted, although the method depends on pitches and depths of irregularity patterns or the material of the surface of the emboss roller 16. Other known processing such as grinding, ultrasonic machining, electrical discharge machining may also be employed.

When forming patterned irregularities on the surface of the nip roller 18, similar methods may be used. On the other hand, when the surface of the nip roller 18 is formed flat and smooth as in this embodiment, generally combination of cutting with a lathe and buffing finish is preferably adopted.

The surface of the emboss roller 16 has a surface roughness Ra of preferably 0.5 μm or less, more preferably 0.2 μm or less.

The emboss roller 16 is rotarily driven in the direction of the arrow in FIG. 1 by an unrepresented driving member at a pre-determined peripheral speed. The emboss roller 16 is also equipped with a temperature control means. Such a temperature control means can control and prevent temperature increase of the emboss roller 16 due to the first resin material 14 (the laminate 32) heated to high temperatures, or sharp drop in the temperature of the roller.

For such a temperature control means, a configuration in which temperature controlled oil is circulated inside the roller is preferably adopted. The oil can be supplied and discharged by means of a configuration in which a rotary joint is put to the end of the roller. The temperature control means is used in the production line 10 for a resin sheet of FIG. 1.

The nip roller 18 presses the laminate 32 of the first resin material 14 and the second resin material 17 closely contacted to the backside thereof with the emboss roller 16, and is positioned against the emboss roller 16 at the same height in the upstream of the traveling direction.

When the backside of the laminate 32 is to be made flat, it is preferred that the surface of the nip roller 18 is mirror finished as described earlier. Such a surface makes the backside of the second resin material 17 (the laminate 32) after molding in good condition. The surface of the nip roller 18 has a surface roughness Ra of preferably 0.5 μm or less, more preferably 0.2 μm or less.

Referring to the material of the nip roller 18, useful are various steel members, stainless steel, copper, zinc, brass, materials having a core made of such metal and rubber-lined on the surface, those metal materials plated with HCr, Cu or Ni, ceramics and various composite materials.

The nip roller 18 is rotarily driven in the direction of the arrow in FIG. 1 by an unrepresented driving member at a pre-determined peripheral speed. A configuration in which no driving member is attached to the nip roller 18 is also possible, but to make the surface of the second resin material 17 (the backside of the laminate 32) in good condition, it is preferred to attach a driving member.

The nip roller 18 is equipped with an unrepresented pressurizing means so as to press the laminate 32 present between the nip roller 18 and the emboss roller 16 at a pre-determined pressure. The pressurizing means applies pressure in the direction of the normal line at the contact point of the nip roller 18 and the emboss roller 16, and known means such as a motor driving means, an air cylinder or a hydraulic cylinder may be used.

For the nip roller 18, a configuration in which bending due to the reaction force to the pressing force is hardly generated may also be employed. For such a configuration, a configuration in which a back-up roller is provided behind the nip roller 18 (opposite side from the emboss roller 16), a configuration employing a crown form (wider at the center), a configuration which has a strength distribution so that the roller has a greater rigidity at the center in the roller axis direction, or a combination thereof may be adopted.

The nip roller 18 has a temperature control means. An optimal preset temperature of the nip roller 18 is selected based on the material of the second resin material 17, the temperature of the second resin material 17 upon melting (e.g., at the slit exit of the die 15), the transfer rate of the second resin material 17 (laminate 32), the outer diameter of the emboss roller 16 and the irregularity pattern of the emboss roller 16.

For the temperature control means of the nip roller 18, a configuration in which temperature controlled oil is circulated inside the roller is preferably adopted. The oil can be supplied and discharged by means of a configuration in which a rotary joint is put to the end of the roller. This temperature control means is used in the production line 10 for a resin sheet of FIG. 1.

Regarding other temperature control means, known means such as a sheath heater embedded inside the roller and a dielectric heating means disposed in the vicinity of the roller may be used.

As described earlier, the first resin material 14 preferably has a glass transition temperature Tg1 lower than the glass transition temperature Tg2 of the second resin material 17. When the thermal deformation of the first resin material 14 is greater than that of the second resin material 17 as just described, greater irregularities can be formed on the surface of the first resin material 14, and this is also effective for making the surface of the second resin material 17 flat.

The glass transition temperature Tg of resin materials is measured by a general method such as measurement of calorimetric change by differential scanning calorimetry (DSC) or measurement of tan δ=G″(loss modulus)/G′(storage modulus) using a rheometer.

Even in the case where irregularities are also formed on the surface of the second resin material 17 unlike this embodiment, irregularities on the surface of the first resin material 14 can be greater and irregularities on the surface of the second resin material 17 can be formed in good condition as long as the first resin material 14 has a greater thermal deformation than the second resin material 17.

In order to monitor the surface temperature at some parts of the rollers, the first resin material 14 and the second resin material 17, a surface temperature measuring means (representation abbreviated) is preferably provided. For such a surface temperature measuring means, various known measuring means such as an infrared thermometer and a radiation thermometer may be employed.

The surface temperature measuring means measures the surface temperature at, for example, several points in the width direction of the first resin material 14 present between the die 12 and the emboss roller 16, several points in the width direction of the first resin material 14 immediately following the releasing roller 24, or several points in the width direction of the first resin material 14 wound onto the emboss roller 16 or the releasing roller 24.

It is also possible to send the results monitored by the surface temperature measuring means to the temperature control means of the rollers, the die 12 and the die 15 as feedback so as to reflect the results in temperature control of the rollers. Alternatively, however, operation with feedforward control without a surface temperature measuring means is also available.

In the production line 10 for a resin sheet shown in FIG. 1 or in the downstream thereof, a tension detecting means for detecting the tension of the laminate 32 or a thickness detecting means for detecting the thickness of the laminate 32 (thickness sensor) is also preferably provided.

A gradual cooling zone 30 (or annealing zone) is provided so as to prevent rapid temperature change of the laminate 32 in the downstream of the releasing roller 24. When the laminate 32 undergoes rapid temperature change, the inside of the laminate 32, for example, remains plastic, while the surface and its neighboring area are already elastic, and due to shrinkage caused by curing in the inside, the surface profile of the laminate 32 is deteriorated. Further, the laminate 32 may be warped due to difference in temperature between the first resin material 14 and the second resin material 17 (the surface and the backside of the laminate).

The gradual cooling zone 30 may be formed like a tunnel in the horizontal direction, and a configuration in which a temperature control means is provided in the tunnel so as to control the cooling temperature profile of the laminate 32 may be adopted. For the temperature control means, known means such as means configure to supply temperature controlled air (hot air or cold air) to the laminate 32 through a plurality of nozzles or means configured to heat both sides of the laminate 32 by a heating means (a nichrome wire heater, an infrared heater, a dielectric heating means, etc.) may be employed.

In the downstream of the gradual cooling zone 30, a washing unit (washing zone), a defect inspection unit (inspection zone), a lamination unit, a side cutter, a cross cutter and a collecting space are provided in that order (representations abbreviated).

Of these, the lamination unit is for bonding a protective film (polyethylene film, etc.) to both sides of the laminate 32. The side cutter cuts both edges in the width direction (waste portions) of the laminate 32, and the cross cutter cuts the laminate 32 evenly into a pre-determined length.

Some of the above units may be omitted depending on the purpose.

The method of producing a resin sheet on the production line 10 for a resin sheet shown in FIG. 1 is now described.

The first resin material 14 and the second resin material 17 used in the present invention may be a thermoplastic resin, and examples thereof include polymethyl methacrylate resin (PMMA), polycarbonate resin, polystyrene resin, MS resin, AS resin, polypropylene resin, polyethylene resin, polyethylene terephthalate resin, polyvinyl chloride resin (PVC), thermoplastic elastomers, copolymers thereof and cyclolefin polymers.

The sheet-shaped first resin material 14 extruded from the die 12 and the sheet shaped second resin material 17 extruded from the die 15 are stacked and pressed by the emboss roller 16 and the nip roller 18 positioned against the emboss roller 16, whereby irregularities on the surface of the emboss roller 16 are transferred to the first resin material 14 and the surface of the second resin material 17 is held flat and smooth by the nip roller 18, and then a laminate of the first resin material 14 and the second resin material 17 are wound onto the releasing roller 24 positioned against the emboss roller 16 to be released from the emboss roller 16.

The laminate 32 of the first resin material 14 and the second resin material 17 released from the emboss roller 16 are transferred in the horizontal direction, gradually cooled while passing through the gradual cooling zone 30, and when strain is removed, the laminate is cut into a pre-determined length and stored as resin sheet products in a product collecting zone in the downstream.

In the production of the resin sheet, the extrusion rate of the first resin material 14 from the die 12 and the extrusion rate of the second resin material 17 from the die 15 may be 0.1 to 50 m/minute, preferably 0.3 to 30 m/minute. Accordingly, the peripheral speed of the emboss roller 16, the nip roller 18 and the releasing roller 24 is substantially consistent with the above rate.

It is preferred that the fluctuation in the rate of the rollers is controlled to within 1% relative to the preset value.

The pressure from the nip roller 18 applied to the emboss roller 16 is preferably 0 to 200 kN/m (0 to 200 kgf/cm), more preferably 0 to 100 kN/m (0 to 100 kgf/cm) on a line pressure basis (value converted assuming the plane contact of nip rollers due to elastic deformation to be line contact).

It is preferred that the temperature of the nip roller 18 and the releasing roller 24 is individually controlled. It is also preferred that the temperature of the first resin material 14 on the releasing roller 24 is not higher than the softening point Ta of the resin. When polymethyl methacrylate resin is used as the first resin material 14, the preset temperature of the releasing roller 24 may be 50 to 110° C.

Next, the irregularity pattern on the surface of the first resin material 14 is described in detail. As described above, FIG. 2 is a perspective view illustrating a linearly cut edge 14A of the first resin material 14 (the laminate 32) after molding. The laminate 32 has a flat backside (the surface of the second resin material 17).

The irregularity pattern on the surface of the laminate 32 (the first resin material 14) is an irregularity pattern linearly extended in the longitudinal direction (the direction shown by the arrow in FIG. 2). This pattern has a repetition of a V-groove 50 formed on the thickest part 14B of the first resin material 14 and taper portions 52, 52 whose thickness is linearly reduced toward the thinnest part 14C of the first resin material 14 from both edges of the V-groove 50. In other words, the pattern has a continuous profile of a unit (1 pitch) of the V-groove 50 and the taper portions 52, 52 on both sides, which is axisymmetric to the center line of the V-groove 50.

Referring to FIG. 2, the thinnest part 14C in the first resin material 14 (or the laminate 32) has a thickness of preferably 5 mm or less, more preferably between 0.5 mm or more and 2 mm or less. The difference in thickness between the thickest part 14B and the thinnest part 14C of the first resin material 14 is preferably 1 mm or more, more preferably 2.5 mm or more. With such a size, the laminate 32 can be suitably used for a light guide plate positioned on the backside of various display devices or various optical devices.

When the laminate 32 is used for a light guide plate, a cylindrical cold-cathode tube is put inside the V-groove 50, and the light emitted from the cold-cathode tube enters the laminate 32 through the surface of the V-groove 50, reflected on the taper portions 52, 52 and irradiated through the backside of the laminate 32 in a planar form.

When the laminate 32 after molding is used for a light guide plate as described above, the V-groove 50 has a width p of preferably 2 mm or more, and an apex angle θ1 of preferably 40 to 80 degrees. The V-groove 50 has a depth Δt of preferably 1 mm or more, further preferably 2.5 mm or more. The taper portions 52, 52 has a tilt angle θ2 of preferably 3 to 20 degrees and a width p2 of preferably 5 mm or more, further preferably 10 mm or more.

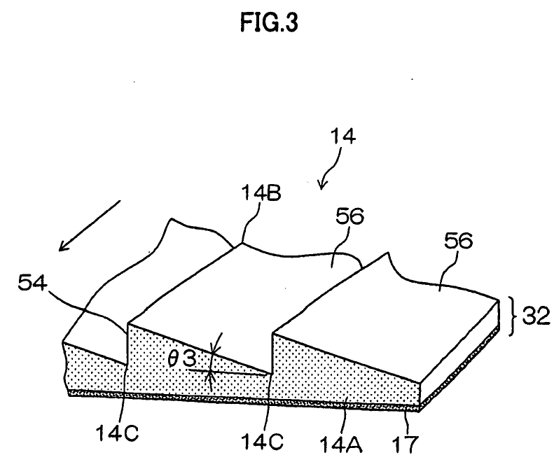

Next, another irregularity pattern on the surface of the laminate 32 is described. FIG. 3 is a perspective view illustrating a linearly cut edge 14A of the first resin material 14 (laminate 32) after molding. The laminate 32 has a flat backside (the surface of the second resin material 17).

The irregularity pattern on the surface of the first resin material 14 (the laminate 32) is an irregularity pattern linearly extended in the longitudinal direction (the direction shown by the arrow in the figure). This pattern having a saw-tooth shaped cross section has a repetition of a vertical wall 54 connecting the thickest part 14B and the thinnest part 14C of the first resin material 14 and a taper portion 56 whose thickness is linearly reduced toward the thinnest part 14C of the first resin material 14 from the upper edge (thickest part 14B) of the vertical wall 54.

Referring to FIG. 3, the thinnest part 14C of the first resin material 14 (or laminate 32) has a thickness of 5 mm or less, more preferably between 0.5 mm or more and 2 mm or less. The difference in thickness between the thickest part 14B and the thinnest part 14C of the first resin material 14 is preferably 1 mm or more, more preferably 2.5 mm or more. With such a size, the laminate can be suitably used for a light guide plate positioned on the backside of various display devices or various optical devices.

When the laminate 32 after molding is used for a light guide plate, a cylindrical cold-cathode tube is put to the side face of the vertical wall 54 and the light emitted from the cold-cathode tube enters the laminate 32 through the surface (side face) of the vertical wall 54, reflected on the taper portion 56 and irradiated through the backside of the laminate 32 in a planar form.

When the laminate 32 after molding is used for a light guide plate, the taper portion 56 has a tilt angle θ3 of preferably 3 to 20 degrees.

When the laminate 32 after molding is used for a light guide plate, another form other than the above forms may also be used. For example, while the first resin material 14 in FIG. 2 has a V-groove 50 having a V-shaped cross section, cross sections other than that, e.g., a rectangular, trapezoidal, circular arc or parabolic cross section may also be adopted as long as optical properties and moldability are satisfied.

Further, irregularities on the surface of the emboss roller 16 may not be opposite from the surface shape of the first resin material 14 in FIG. 2 or FIG. 3. In view of the shrinkage allowance of the first resin material 14, irregularities may be an offset form of those shown in FIG. 2 or FIG. 3 so that the produced laminate 32 has the shape shown in FIG. 2 or FIG. 3.

According to the method of producing a resin sheet of the present invention described above, the desired cross-sectional shape can be obtained even in the case of a resin sheet with a wide thickness distribution in the width direction upon molding.

While embodiments of the method of producing a resin sheet of the present invention have been described above, the present invention is not limited to the above-described embodiments and various modes are available.

For example, various modes other than the present embodiments are available for the number and the position of nip rollers as long as similar function is obtained.

Further, various modes other than the present embodiments are available for the gradual cooling zone 30 as well, as long as similar function is obtained.

1.-5. (canceled)

6. A method of producing a resin sheet, comprising:
stacking a sheet-shaped first resin material extruded from a first die and a sheet-shaped second resin material extruded from a second die;
pressing the stacked resin materials with an emboss roller and a nip roller positioned against the emboss roller so that the first resin material comes into contact with the emboss roller and the second resin material comes into contact with the nip roller;
transferring irregularities on the surface of the emboss roller to the first resin material and closely contacting the first resin material to the second resin material; and
releasing the closely contacted first resin material and second resin material from the emboss roller by winding the closely contacted materials onto a releasing roller positioned against the emboss roller.

7. The method of producing a resin sheet according to claim 6, wherein the nip roller and/or the releasing roller have/has irregularities on the surface.

8. The method of producing a resin sheet according to claim 6, wherein the first resin material has a glass transition temperature Tg1 lower than a glass transition temperature Tg2 of the second resin material.

9. The method of producing a resin sheet according to claim 7, wherein the first resin material has a glass transition temperature Tg1 lower than a glass transition temperature Tg2 of the second resin material.

10. The method of producing a resin sheet according to claim 6, wherein the irregularities transferred to the first resin material and/or the second resin material create a difference in thickness in the width direction between the thickest part and the thinnest part of a laminate of the first resin material and the second resin material of 1 mm or more.

11. The method of producing a resin sheet according to claim 7, wherein the irregularities transferred to the first resin material and/or the second resin material create a difference in thickness in the width direction between the thickest part and the thinnest part of a laminate of the first resin material and the second resin material of 1 mm or more.

12. The method of producing a resin sheet according to claim 3, wherein the irregularities transferred to the first resin material and/or the second resin material create a difference in thickness in the width direction between the thickest part and the thinnest part of a laminate of the first resin material and the second resin material of 1 mm or more.

13. The method of producing a resin sheet according to claim 9, wherein the irregularities transferred to the first resin material and/or the second resin material create a difference in thickness in the width direction between the thickest part and the thinnest part of a laminate of the first resin material and the second resin material of 1 mm or more.

14. The method of producing a resin sheet according to claim 6, wherein a laminate of the first resin material and the second resin material has a thickness of 5 mm or less at the thinnest part.

15. The method of producing a resin sheet according to claim 7, wherein a laminate of the first resin material and the second resin material has a thickness of 5 mm or less at the thinnest part.

16. The method of producing a resin sheet according to claim 8, wherein a laminate of the first resin material and the second resin material has a thickness of 5 mm or less at the thinnest part.

17. The method of producing a resin sheet according to claim 9, wherein a laminate of the first resin material and the second resin material has a thickness of 5 mm or less at the thinnest part.

18. The method of producing a resin sheet according to claim 10, wherein a laminate of the first resin material and the second resin material has a thickness of 5 mm or less at the thinnest part.

19. The method of producing a resin sheet according to claim 11, wherein a laminate of the first resin material and the second resin material has a thickness of 5 mm or less at the thinnest part.

20. The method of producing a resin sheet according to claim 12, wherein a laminate of the first resin material and the second resin material has a thickness of 5 mm or less at the thinnest part.

21. The method of producing a resin sheet according to claim 13, wherein a laminate of the first resin material and the second resin material has a thickness of 5 mm or less at the thinnest part.
